(19) United States
(12) Patent Application Publication
(10) Pub. No.: US 2013/0124257 A1
(43) Pub. Date: May 16, 2013

(54) ENGAGEMENT SCORING

(71) Applicant: Aaron Schubert, Bozeman, MT (US)

(72) Inventor: Aaron Schubert, Bozeman, MT (US)

(21) Appl. No.: 13/294,872

(22) Filed: Nov. 11, 2011

(51) Int. Cl. G06Q 10/06

(52) U.S. Cl. 705/7.29

(57) ABSTRACT

Systems and methods determine an engagement score reflecting a level of engagement for a customer with a company. The engagement score is determined using data from past interactions the customer has had with the company and using other factors such as sentiment expressed in interactions and the recency of interactions.

### FIELD

This disclosure relates generally to systems and methods for maintaining customer relationships, and more particularly, to determining an engagement score that indicates a level of customer engagement with a company.

### BACKGROUND

Companies are constantly trying to determine the most profitable way to interact with their customer base. They have been trained to base their segmentation of customers off of statistics around prior communications and a perceived customer lifetime value. These traditional methods cannot provide insight into the level of engagement that the individual has with the company or brand. All companies are effectively looking for a way to measure the engagement levels of their customers so that they can form lasting relationships with these individuals maximizing the revenue potential from each of them.

Traditional methods that attempt to determine customer engagement typically focus specifically on the quantity of transactional data and the supposed customer lifetime value. While being useful components, on their own they do not provide the basis for providing a true level of engagement. Recent technology trends along with the service driven nature of business has made these views of engagement outdated.

### BRIEF DESCRIPTION OF THE DRAWINGS

For a better understanding of the inventive subject matter, reference may be made to the accompanying drawings in which:

FIG. 1 is a block diagram of a system according to embodiments of the invention.

FIG. 2 is a flowchart describing a method for determining an engagement score according to various embodiments;

FIG. 3 is a flowchart describing a primary interaction opportunity path for an individual contact.

FIG. 4 is a flowchart describing a primary interaction opportunity path 400 for an individual contact.

FIG. 5 is a flowchart of a method for using secondary interaction information to update an interaction score.

FIG. 6 is a flowchart illustrating how the methods of FIGS. 2-5 can interact as part of a larger method.

FIGS. 7-11 illustrate examples of the operation of the systems and methods in response to various interactions.

FIGS. 12-16 are example screen images.

FIG. 17 is a block diagram of an example embodiment of a computer system upon which embodiments of the inventive subject matter can execute.

### DETAILED DESCRIPTION

In the following detailed description of example embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. In general, the first digit(s) of the reference number for a given item or part of the invention should correspond to the Figure number in which the item or part is first identified.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

Described herein are systems and methods for calculating an engagement score which businesses can use along with a view into recent transactional history to identify various levels of engagement within their customer base. The combination of the top level score along with recent transactional data can be used to provide an engagement scorecard. The flexibility available which allows the user to output all related data alongside the calculated engagement score as well as the ability to filter based on data important to the business makes the engagement score and engagement scorecard a powerful interactive tool.

### Overview

The systems and methods described herein provide companies the ability to not only focus on the interactions they are having with their customers but in addition be aware of how their customers are portraying the accounts of these interactions to others. The expansion of social networks and online forums has made it desirable for companies to look outside of their private domain and be fully aware of the conversations that are taking place which will affect their bottom line. Power has shifted to the consumer making it very desirable for companies to identify who their largest promoters are and to cultivate a relationship with these individuals that will lead to them promoting the brand to their friends, family, and business contacts. Previous systems' reliance strictly on purchase history for customers is simply not good enough as it does not account for the revenue opportunity available in each contact's personal network. Similarly, looking at the quantity of previous interactions does little to help determine an engagement level on its own. It is thus desirable to look deeper into these interactions to determine the overall quality of each interaction and whether the transaction had a net positive or negative effect on the customer/business relationship.

The use of timing around customer interactions is also desirable when determining engagement, but not considered in traditional approaches. If a consumer is not continually engaging with the brand then the overall number of transactions is meaningless. This is an area where traditional engagement calculations typically fall short as they do not properly weigh the historical vs. recent timestamp associated with various transactions.

The embodiments of the invention solve a valuable marketplace problem of determining engagement levels for contacts based on the many important factors influencing today's business. It combines the necessary transactional information and customer equated value with more intimate detail that the system learns from these experiences while simultaneously considering the time that the interactions occur. Social influence as well as customer sentiment are taken into account to create an engagement score and scorecard which presents a view showing an overall engagement score as well as the recent interactions with the customer.

For illustrative purposes, the embodiments of the present invention are discussed below with reference to a company that utilizes multiple channels to communicate with customers as well as various channels to monitor cloud based or other external communication that affects their business. The specific examples discussed are only examples of suitable environments and are not intended to suggest any limitation as to the scope of use or functionality of the invention. Additionally, none of the description provided herein should be interpreted as a basis for any dependency or requirement relating to any one or a combination of components illustrated in the example operating environments described herein.

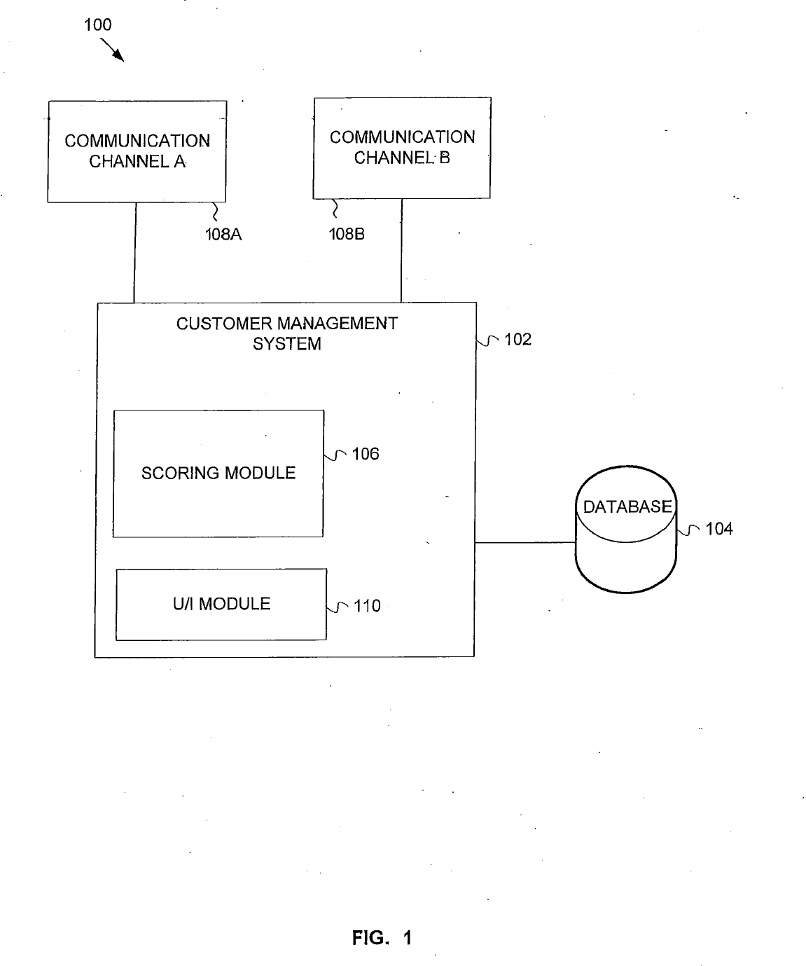

FIG. 1 is a block diagram of a system 100 according to embodiments of the invention. In some embodiments, system 100 includes a customer management system 102 having communications channels 108. In some embodiments, customer management system 102 may be a Customer Relationship Management (CRM) system. Customer management system 102 provides an interface for a company's sales, marketing and/or support staff to efficiently handle interactions with customers or potential customers. Customer management system 102 in various embodiments can include marketing functions, sales functions, product support functions, and analytics functions.

Database 104 may be coupled to customer management system 102, and used to maintain data to support the functions provided by customer management system 102. Although shown as one database in FIG. 1, database 104 may be distributed across multiple databases.

Customer management system 102 may be coupled to various communications channels 108. A communications channel 108 can be any communications mechanism that can be used to communicate with a customer. Examples of such communications channels include telephone, text messaging systems, electronic (email) systems, social networking systems, web sites etc. A customer may initiate a contact with sales or support staff through any of the various communications channels supported by customer management system 102. Further, contact may be initiated using one communications channel (e.g., telephone), and continued through a different communications channel (e.g., email). Although two communications channels 108A and 108B are shown in FIG. 1, those of skill in the art will appreciate that other communications channels may be coupled to customer management system 102.

Communication channels may be directly connected (e.g., a phone line) or they may be connected via a broadcast medium such as a network (wired or wireless). In some embodiments, a network may be a collection of networks such as the Internet.

Customer management system 102 includes scoring module 106. Scoring module 106 receives various factors and parameters associated with a customer as input and uses the factors and parameters to produce an engagement score that rates the degree of engagement a customer has with a company. In some embodiments, these factors include various combinations of one or more of: social factor, recency component, customer sentiment, outbound communication interaction level (conversion rate), and individual transactional data. Additional components that may define all or part of a score calculation not explicitly described herein are also considered and covered by the claim language and no limitation is implied or inferred by the herein described list. These factors may be gathered using any of the channels described above and are used by score module 106 along with other available data to calculate an engagement score. In some embodiments, the engagement score may be provided as a value with a range of 0 to 100, but one of ordinary skill in the art having the benefit of the disclosure can easily identify any number of different and equally valid numeric ranges.

The engagement score determined by scoring module 106 may be used in various ways. For example, in some embodiments, the engagement score may be presented along with the most recent transactional data from various channels to form the engagement scorecard that is presented by user interface (U/I) module 110. Examples of scorecard usage and display are further described below. The factors noted above are not meant to be all encompassing as any information around the attributes could also be included in determination of an engagement score. For example, personal purchase history, organizational data, location, gender, age, nationality, income, and familial information may be provided along with the engagement score.

The pieces of data (or influencers) of the engagement score described below are desirable in determining the overall engagement level of a customer with a company. The embodiments do not require any particular combination of these influencers. Moreover, additional data may be useful in determining the final engagement score.

The first influencer earlier referenced is the social factor. The social factor refers to the ability for one customer to influence their entire network which can provide a windfall of recognition and eventual revenue to a business. Social media sites have overtaken search engines as the primary source of traffic on the internet and trends show that their popularity will only continue to rise. This means that it is desirable for a business to have a presence in this area and to be able to make sense of interactions occurring in this space. Without this component, it is difficult to properly value a customer that spends very little but is very pleased with the brand and willingly promotes the company's product or services to their friends and family A traditional method would undervalue this individual whereas the calculation of engagement described herein will take this into account giving the individual a higher score based on their involvement with social media. Companies desire to know who these people are as they can be useful in causing information about the company to spread virally. This is a desirable channel for companies who are trying to spread brand awareness to new consumers.

There are a variety of ways the social factor can be influenced. The first involves cases where a contact somehow redistributes material received from the company in question. This can include forwarding offers via email, reposting links to offers via the web, referring their friends via phone or direct mail, and all other avenues that an individual can utilize to expose their friends, family, and their larger social network to a company. As a result of tracking the source of these new contacts back to the original influencer, the social factor is then influenced. The number of interactions resulting from this viral marketing effort will determine the overall effect on the social factor aspect of the engagement score. The second aspect of the social factor is simply the ability to track interactions that the individual has with the specific company or brand in a social network, forum, or some other environment outside of the company's control. Examples of this would include the individual making posts including either the company name or referencing a specific product delivered by the company. These interactions are of utmost importance due to the fact that they represent unsolicited feedback intended for one's friends and family which can lend much greater insight than traditional feedback approaches. In cases where the post occurs on a forum where the user's reputation is measurable, this will also influence the weight with which the social factor is influenced, as well-respected individuals on the forum will have a higher probability of influencing others in that particular network.

Customer sentiment is another factor that has previously been undervalued when determining engagement. The engagement score calculation described herein has a component that is based off of previously patented technology (U.S. Pat. No. 7,289,949, incorporated by reference in its entirety herein) which calculates a score (based on a free text correspondence) meant to gauge emotion. Customers that are determined to have more positive emotions in their interactions with the brand will consequently have a higher engagement score. This is desirable because it allows the score to be influenced by the quality of both solicited (feedback mechanisms) and unsolicited (monitoring the cloud) feedback as opposed to just the number (quantity) of interactions. Traditional approaches are not known to have systematically included this information as part of any analysis of engagement.

Data received as a result of measuring a customer's interaction level with an outbound communication interaction level is also used to calculate the engagement score in some embodiments. Examples of this include measuring the opened and click-through rates of outbound emails, but can be extended to include all levels of interest/conversion through various channels that a business uses for its outbound communication. Some embodiments gauge the number of interactions. Alternative embodiments also include the percentage of times the user actually chooses to interact with the information. This can be useful to determine if a company is over-communicating to the customer. For the purposes of this document, this factor is referred to as the conversion rate. In some embodiments, the conversion rate is also affected by occurrences of bounced emails, returned direct mail, or unsubscribe transactions. These would in turn lower the conversion score component.

Another factor used by some embodiments to calculate an engagement score is a transactional history. The more transactions a contact has with the brand then the more engaged they are. The transactional data can be collected from any interactive channel that the company provides for its customers as well as those that exist in the public domain that the customer chooses to utilize, hence any of the multiple touch points a user chooses to interact with a company can be accounted for. Examples of this transactional data include: phone interactions, chat interactions, voice interactions, web related activity, social network traffic, purchase history, and community reputation. One of ordinary skill in the art having the benefit of the disclosure can easily identify additional transactional data elements of relevance and the cited list is not intended to be exhaustive. The transactional history component, in conjunction with the recency factor can be used in some embodiments to ensure that only contacts with many recent transactions receive the highest engagement score.

The factors listed above (and the data used to derive the factors) can be stored in database 104 and used in various combinations to provide the basis for calculation of the engagement score. Further details on the operation of the system described are provided below.

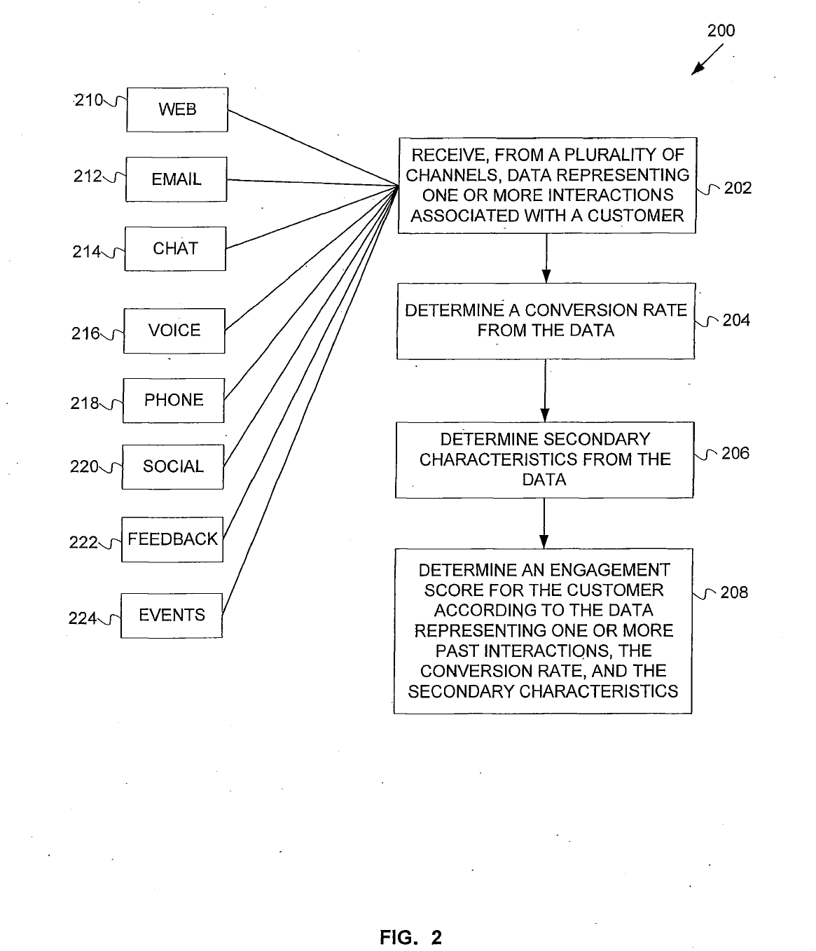

FIG. 2 is a flowchart describing a method 200 for determining an engagement score according to various embodiments. The method may, in some embodiments, constitute computer programs made up of computer-executable instructions. Describing the method by reference to a flowchart enables one skilled in the art to develop such programs including such instructions to carry out the method on suitable processors (the processor or processors of the computer executing the instructions from machine-readable media). The method illustrated in FIG. 2 is inclusive of acts that may be taken by an operating environment 100 executing an example embodiment of the invention.

At block 202, a customer management system receives data from a plurality of channels. As noted above, data may be received from various types of communications channels, including web data 210, email data 212, chat data 214, voice data 216, phone data 218, social data 220, feedback data 222, and event data 224. The data illustrated in FIG. 2 provides an illustration of the various channels that can lead to interactions which are accounted for in the engagement scorecard. Once again, this is not meant to be an exhaustive list as one of ordinary skill in the art can identify additional sources that could be used to provide information to the engagement score calculation.

Web data 210 includes form interaction from marketing campaigns as well as service interactions or basic navigation via the company's site.

Email data 212 includes any transactional data associated with emails sent to the customer. This includes views, clicks, bounces, and unsubscribe actions.

Chat data 214 includes chat session data that is logged and utilized when calculating the score.

Voice data 216 includes data regarding customer interactions creating a ticket through an IVR (Interactive Voice Response) system.

Phone data 218 includes data regarding interactions between a customer service agent and the customer.

Social data 220 includes data regarding interactions on networks such as Twitter, Facebook, YouTube, LinkedIn, MySpace, and Flickr. Such interactions can be used to determine an engagement score. Forum interactions can also be counted in this category.

Feedback data 222 includes survey data received from various channels.

Event data 224 includes data obtained during any events hosted/attended by the business. Such data can act as sources for information which can feed into the engagement score calculation.

The data described above can be data regarding a direct interaction between the customer and the company. For example, the customer may have recommended the company or a product of service of the company on a social media site. Alternatively, the data can be data regarding an indirect interaction such as data indicating the customer forwarded an email describing company products or services to a third party, who then acted on the email in some way.

At block 204, the scoring module determines a conversion rate factor for the customer. As noted above, the conversion rate factor is a measure of the customer's interactions with outbound communications from the company to the customer. For example, the scoring module can analyze the number of times the customer has opened emails, responded to surveys, interacted with a web site etc.

At block 206, the scoring module determines scoring factors associated with secondary characteristics of interactions with customers. Such secondary characteristics include characteristics that are not explicitly included in the content of communications or interactions with the customer, but can be derived from communication or interaction. Examples of such secondary characteristics include the sentiment factors and recency factors described above.

At block 208, the scoring module determines an engagement score from the conversion rate factor and the secondary characteristics determined at blocks 204 and 206. In addition, the scoring module may use other factors such as data in past transactions with the customer or a social factor as described above. The various factors and data used to determine the engagement score may be individually weighted so that some factors have a greater impact on the engagement score than other factors. The weighting for particular factors may be configurable by a user.

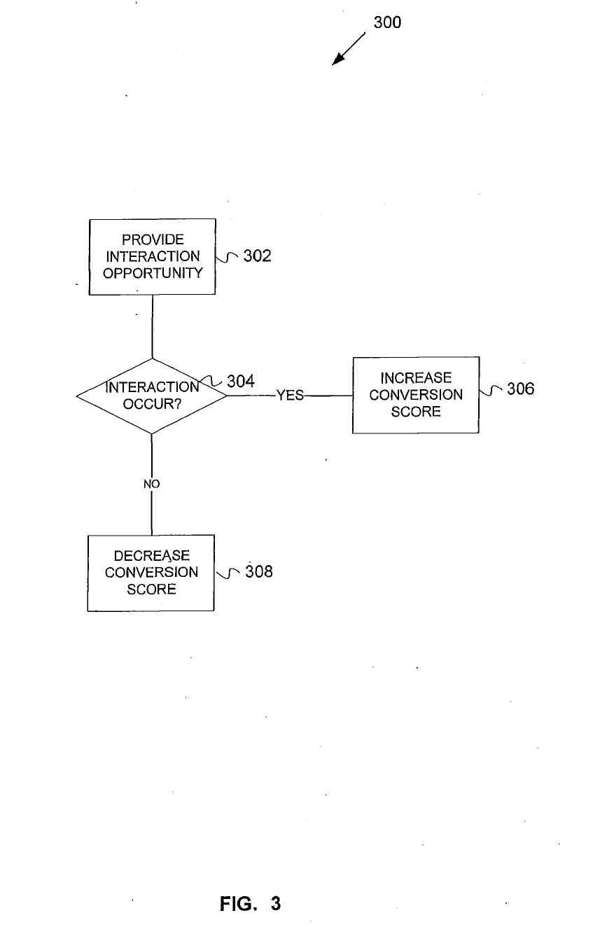

FIGS. 3-6 provide further details on the operations described above in FIG. 2.

FIG. 3 is a flowchart describing a primary interaction opportunity path 300 for an individual contact (customer or potential customer) maintained by customer management system 102. At block 302, an interaction opportunity is provided for the contact. The interaction opportunity may take various forms. For example, the contact may have been sent an email providing marketing information about the company's products or services or inviting the contact to participate in a survey. The interaction opportunity may be a web site that provides the ability for the contact to interact with the company (e.g., provide feedback, seek information about the company etc.). Other forms of interaction opportunities include chat, twitter etc.

At block 304, the system determines if an interaction occurred as a result of providing the interaction opportunity. For example, the system determines if the contact opened an email, accepted a chat, subscribed (follows) tweets or otherwise responded to an interaction opportunity.

If the system determines that the contact responded to an opportunity, then at block 306 a conversion score associated with the contact is increased. However, if the system determines that the contact did not respond to the opportunity, then at block 308 a conversion score associated with the contact is decreased.

The system may iterate through blocks 302-308 for a list or set of various interaction opportunities provided by, or on behalf of, a company.

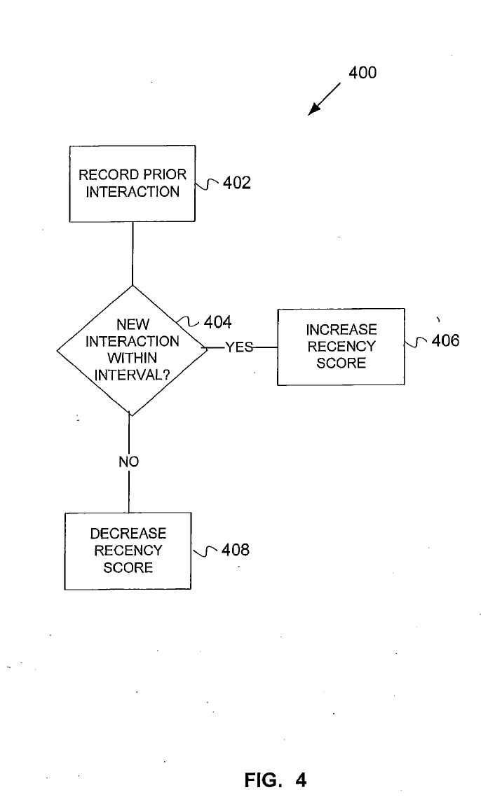

FIG. 4 is a flowchart describing a primary interaction opportunity path 400 for an individual contact. The method begins at block 402 by recording a prior interaction, for example, storing a record of the interaction in database 104.

At block 404, the system determines if there have been any new interactions within a predetermined time interval. The time interval may be configurable by the company.

If the system determines an interaction occurred within the time interval, then in some embodiments, at block 406 the system increases a recency score for the contact. In alternative embodiments, the system may leave the recency score the same and only adjust the recency score if no response to the opportunity was provided by a contact.

Alternatively, if the check at block 404 determines that there has been no interaction within the time interval, then at block 408 the recency score is decreased.

Blocks 402-408 may be repeated for some or all of the contacts maintained by a customer management system 102.

Further, multiple time intervals may be used, with each different time interval having a different impact on the recency score for the contact. Specifically, for a single contact the time interval may be iteratively updated to cover a range of intervals such as 1 month, 6 months and 1 year. In this case there may be no new qualifying interaction opportunities between recency score calculations yet the recency score calculations are performed on each subsequent interval. In other words, the recency score calculation activities can occur on a schedule based upon the time interval independent of the system providing any new interaction opportunities for a contact. The schedule of determining recency scores for contacts may be configured by the system operator.

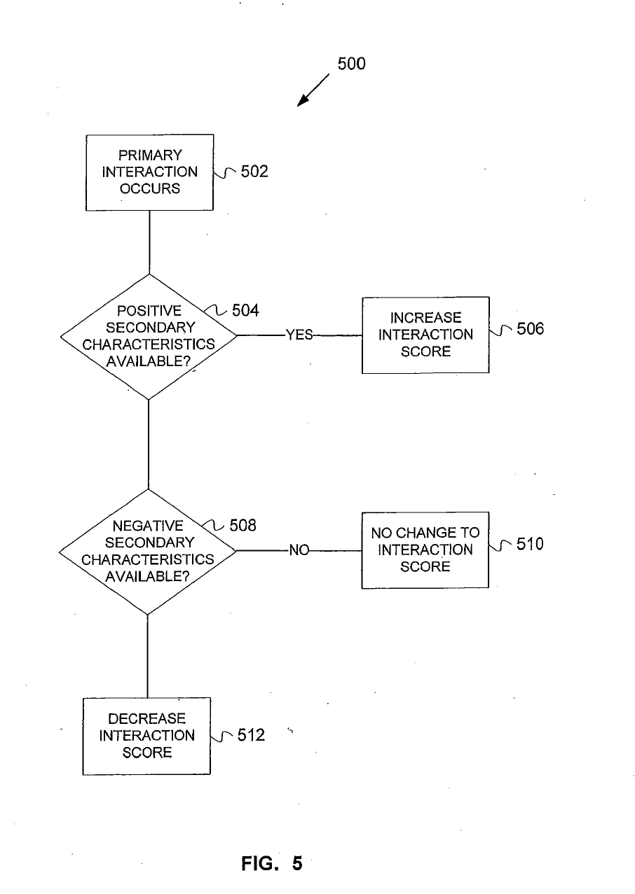

FIG. 5 is a flowchart of a method 500 for using secondary interaction information to update an interaction score. At block 502, a primary interaction between a contact and a company occurs (e.g., the contact responds to a survey or re-posts a mailing on a social channel).

At block 504, the customer management system determines if any positive secondary characteristics are available. Examples of such secondary indicators include determining if any emotion indicators are present in the response, or if the response contains social influencer information. If positive secondary characteristics are available, i.e., positive emotions are expressed in the response, then at block 506 the interaction score is increased.

If there are secondary characteristics available but they are not identifiable as positive, then at block 508 the system evaluates the response to determine if the response has negative secondary characteristics. If negative secondary characteristics are present in the response (i.e., the response has content indicating negative emotions are expressed), then at block 512 the system decreases the interaction score.

If the secondary characteristics are not interpretable as positive or negative no change is made to the interaction score. Processing continues for both the neutral and negative secondary characteristics as with the positive secondary characteristics. Notably, the sequence of identifying positive first followed by negative could be reversed with no change in functionality In some embodiments, the interaction score is updated directly based upon the outcome of the secondary characteristic score and not as part of a sequential update.

Blocks 502-512 may be repeated, as desired to determine additional secondary characteristics in a response, to determine secondary characteristics for additional responses from a particular contact, and to determine secondary characteristics for other contacts.

It should be noted that with respect to determining positive and negative characteristics of a response, there can be situations where negative emotion scores could be considered positive characteristics. For example, if most interaction scores are very negative (most interaction scores by a contact, or most interaction scores for a given interaction across contacts), but the current score is only slightly negative, that slightly negative score is contextually positive. Similarly, if most interactions are very positive, an interaction that is mildly positive may be contextually negative by the same reasoning. While this description is clear for trends in emotion, it can equally apply to any other secondary characteristic and is not limited to the specific cited examples. Social sharing rates and every other secondary characteristic disclosed herein incorporate the same contextual reliance on positive and negative characteristics during the update of the interaction score

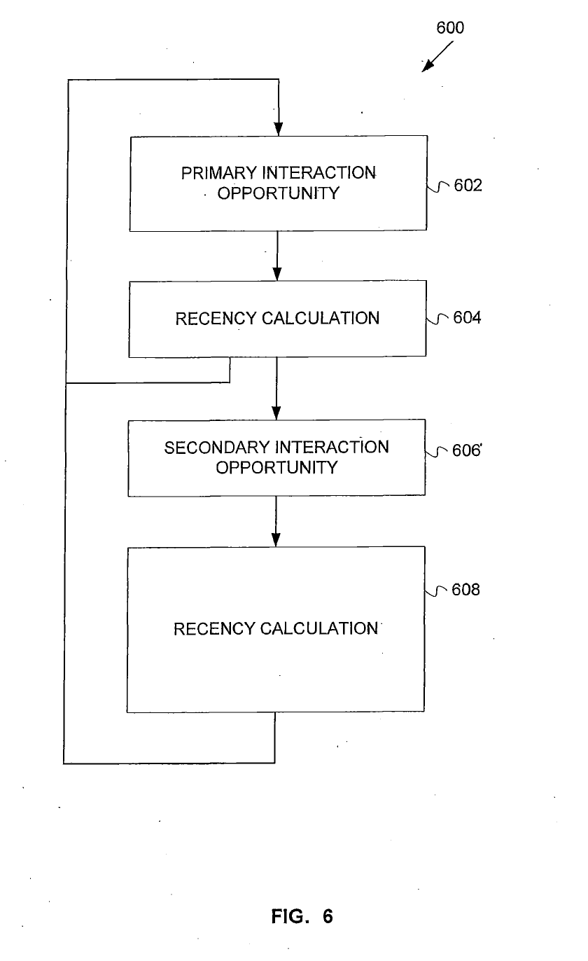

FIG. 6 is a flowchart illustrating how the methods of FIGS. 2-5 can interact as part of a larger method 600. At block 602, a primary interaction opportunity is processed by method 300 (FIG. 3), processing continues at block 604 with a recency calculation according to method 400 (FIG. 4). From here the processing may return to block 602 to begin again with other interactions, or at block 606, secondary interactions may be processed according to method 500 (FIG. 5). If secondary interactions are considered then the recency calculation from method 400 (FIG. 4) can be (optionally) performed before processing returns to block 602 to continue processing other interactions from the beginning. As noted earlier, each of methods 300, 400 and 500 can independently iterate around interactions or recency calculations or may be part of a larger system similar to what is shown in FIG. 6.

Any of the data shown in the referenced figures or described above can also be utilized to create segments. A segment is defined here to be a dynamic audience (set of customers or potential customers and contacts) based on specific criteria to target certain areas of a company's customer base for various offers, promotions, announcements, or any other customer lifecycle purpose. Segmenting one's contact base is desirable to ensure that revenue potential for each contact is maximized. It has been proven to be much more expensive to recruit new customers compared to cultivating existing relationships. The engagement scoring provided by various embodiments of the invention allows a business many ways to segment or dissect their customer base. This means that the company can not only segment off of the score itself but can also utilize combinations of the score and other transactional or personal data to identify specific segments in their customer base.

Examples of the operation of the above-described systems and methods will now be provided. The examples illustrate how different interactions or lack thereof affect the engagement score. The examples discussed below use calculations to derive an engagement score that may be specific to that example, the inventive subject matter is not limited to the descriptions below. As one of ordinary skill in the art having the benefit of the disclosure will appreciate, the specific calculations for any particular contact or interaction will vary due to the fact that each contact has many factors influencing the score at any one point in time and such factors together provide the final engagement score. Calculations can involve any of a variety of biases or weights either inherent in the system or based upon individual preferences. The examples are meant to provide distinct interactions and describe how those interactions will influence the engagement score. In some cases, the interaction will influence multiple portions of the score but only a single aspect will be taken into account in the figure and discussion of the example. The starting point in one example could easily correlate to intermediate steps in other examples meaning it is not meant to signify an absolute starting point.

As noted above, engagement scoring may be provided by a customer management system, an example of which is a CRM system. As would be apparent from the review of the foregoing, the systems and methods described herein are applicable to other environments and implementations. In order to further illustrate the advantages and facilitate an understanding of the various embodiments of the invention, a number of examples applicable to CRM marketing software are provided below. These examples may also illustrate other applications for the engagement scoring described herein. Engagement scoring can be used in a variety of capacities, only a few are referenced in the following examples. One of ordinary skill in the art having the benefit of the disclosure can easily identify additional capacities, and the uses described herein are meant to be descriptive but not exhaustive.

### Example 1

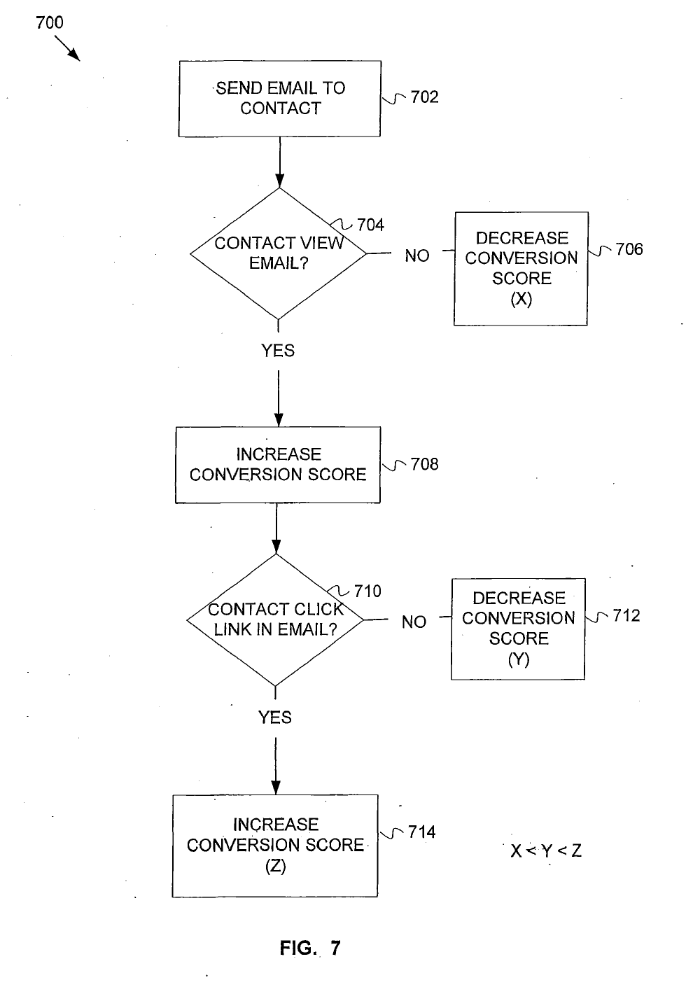

FIG. 7 illustrates the way the engagement score is affected by the open rate of emails sent to a customer (block 702) as well as the click-through rate of these same emails. The system determines if the email was viewed (block 704). The conversion factor component of the engagement score increases if there is an email view recorded (block 708) and likewise decreases if there is not (block 706). The system also determines if the user clicks on a link in the email (block 710). The conversion factor is decreased if the user does not click on a link in the email (block 712) and increased if a link in the email is clicked (block 714). The diagram's flow is dependent on the fact that a user cannot click a link in a document that they did not first view. This fact provides the basis for the score comparison X<y<Z shown in the example.

### Example 2

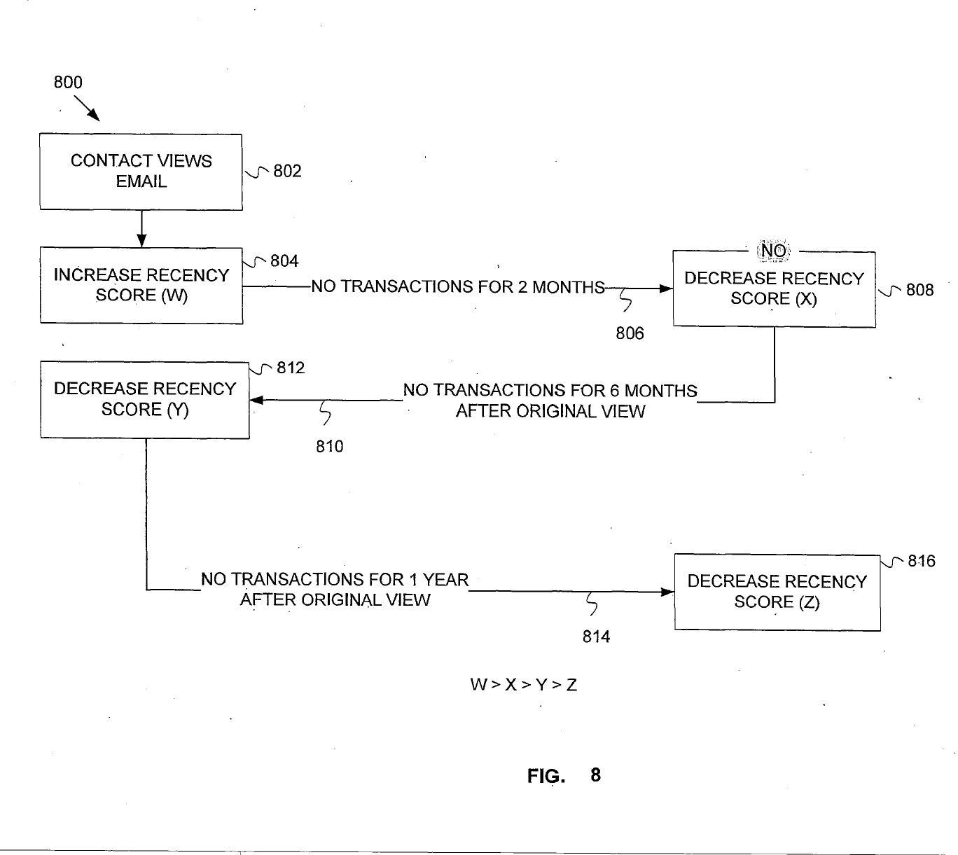

FIG. 8 illustrates the recency factor or time degradation component of the engagement score. Specifically, it shows how in some embodiments, older transactions do less to positively influence the score as compared to recent ones. One of ordinary skill in the art can note in this example that the email view (block 802) would also raise the conversion rate of the score referred to in example 1. However this example focuses specifically on recency. The recency component is initially boosted (block 804) by the email view (block 802). However, the associated recency score associated with the contact degrades over time (blocks 808, 812 and 816) due to no new transactions being recorded after various time intervals (blocks 806, 810 and 814). Eventually, the recency component is lost due to the fact that this contact has not had any form of engagement with the company in over a year. (It should be noted that other time intervals may be arbitrarily set and then the “over a year” interval is merely an example.)

### Example 3

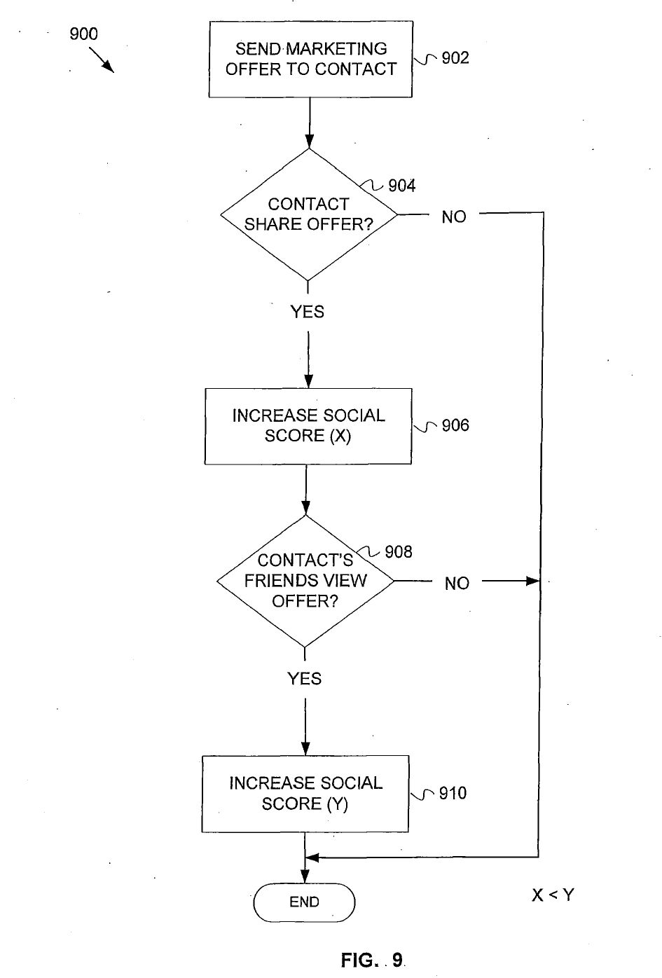

FIG. 9 illustrates how the score can be affected by a social factor. A marketing offer is sent to a contact (block 902). The system determines if the contact has shared or published the offer on a social network (block 904). The social factor component of the engagement score is increased when the user chooses to share or publish content to their social network (block 906). The system further determines if any friends of the contact have clicked-through to view the offer (block 908). The score is further increased when the user's connections follow the link and view the supplied content (block 910). Other examples of the social factor include the user having forwarded email content to others, having posted comments about the company on social networks, or having signed up to effectively follow the company on a social network or other methods, all of which is contemplated and within the scope of the inventive subject matter.

### Example 4

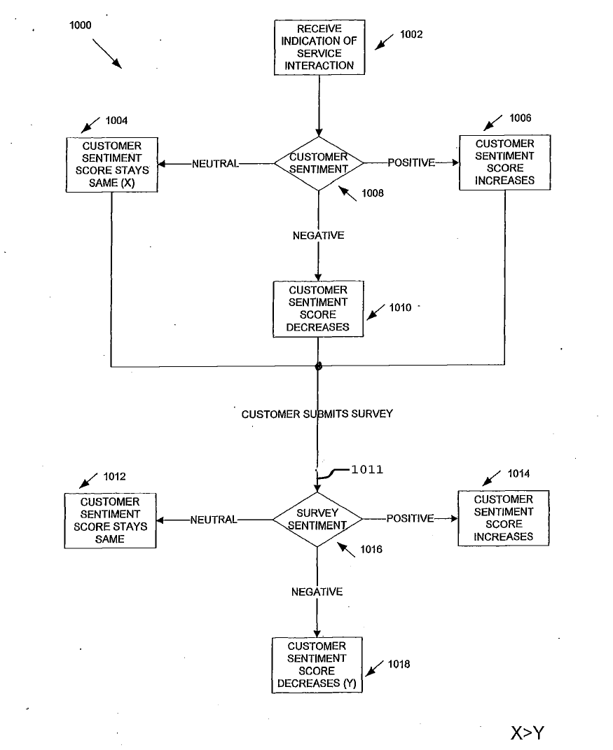

FIG. 10 shows how the engagement score cal) be affected by a sentiment a customer has toward the company. The customer has a service interaction when they call into the company's technical support call center (block 1002). For the purposes of the example, assume that the original question posed by the contact is ‘I need some assistance with the phone I just purchased’. This results in a neutral emotion score which is analyzed in block 1008 which leaves the customer sentiment portion of the engagement score unaffected (block 1004). This neutral score does not trigger any further scoring. After the agent and the customer have completed the interaction, a survey is sent along asking for feedback at 1011. One of the survey questions is ‘Please provide any additional comments or feedback’. The contact's response is ‘I am extremely disappointed in the turnaround time for my issue. It took much too long to get this issue resolved’. This negative response is analyzed at the survey sentiment block 1016 which determines that the survey sentiment was negative and passes same to block 1018 which will result in lowering the overall engagement score (block 1018). In a similar manner a neutral response at block 1016 causes customer sentiment to stay the same in block 1012. A positive response causes the customer sentiment to increase in block 1014.

It should be noted that the examples provides a relatively simple view of adjusting an engagement score by a sentiment factor. However, in actual usage, an average of all emotion ratings for free text (from a variety of touch points and/or channels) provided by a customer (via solicited or unsolicited methods) are utilized to modify this aspect of the engagement score. Other methods of sentiment analysis are equally valuable and within the scope of the inventive subject matter.

### Example 5

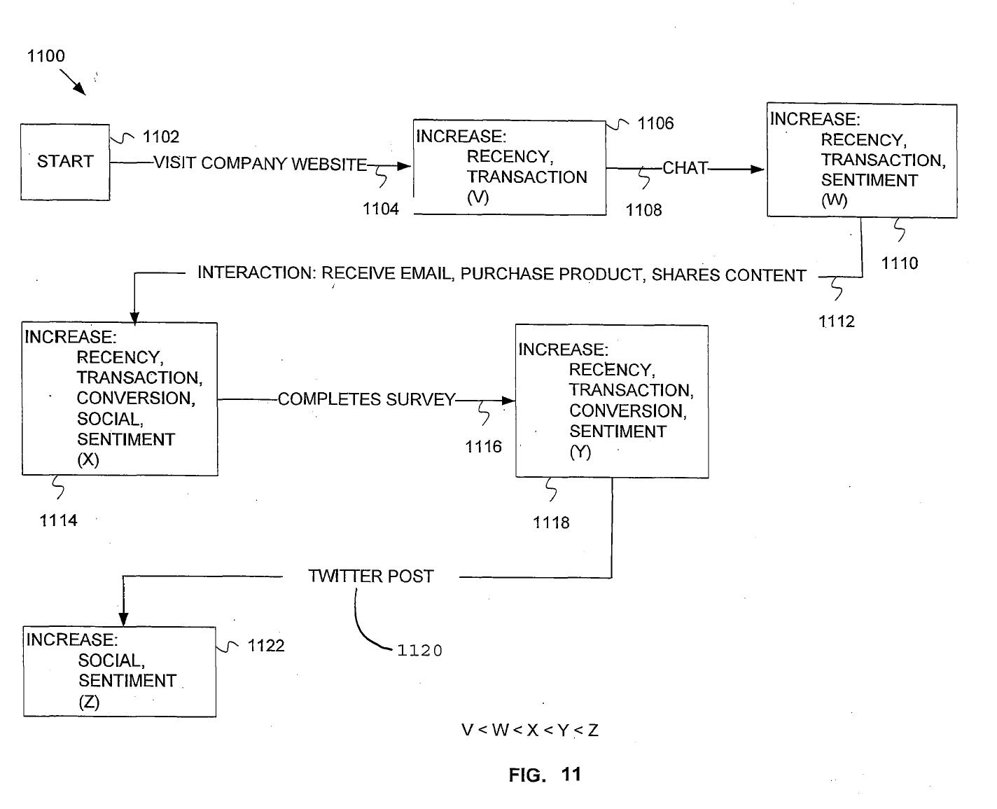

FIG. 11 illustrates an example scenario having multiple interactions and shows different ways in which the example scenario affects the engagement score. Previous examples have focused on specific score aspects whereas the example shown in FIG. 11 provides a broader understanding of the factors influencing the engagement score. Once again, this is just one example scenario among many possible scenarios for a single contact illustrating interactions and factors that can be taken into consideration when calculating the engagement score. This single customer scenario is not meant to cover all possible touch points or score indicators. Other methods are equally valuable and contemplated and within the scope of the inventive subject matter.

In the example illustrated in FIG. 11, assume that a customer, “John”, visits a gaming company's website 1104 and begins searching the knowledgebase concerning an upcoming game that is to be released. This interest triggers logic 1108 to provide a proactive chat window to John asking if he would like to speak to a person concerning details of the highly anticipated game. John chooses to accept the chat request and has a short conversation with the company representative about the game. At the end of the chat, a marketing email is triggered which sends an offer for a 10% discount if the game is purchased online. The email also contains links that allow John to share this information with his network on Facebook. John is so excited that not only does he purchase the game 1112; he clicks through and shares the offer on his Facebook account with a note saying how great a deal the online purchase is. When the time has come for the game to be released, John's copy is sent to him. A survey is then sent one week later 1116 which John fills out explaining how excited he is with his purchase. John also posts on twitter 1120 and challenges his friends to see if anyone can match his skills one-on-one.

In virtually every aspect of this customer journey, there are multiple factors of the engagement score that are being affected. John's presence on the customer's website will raise the score (block 1106) by providing a transaction and also giving full credit to the recency factor (it just happened). At that point, John has even more transactions 1110 as the chat and purchase are also accounted for. It can be assumed that each transaction also is accompanied by affecting the recency factor. The threaded conversation taking place during the chat 1108 is also factored into the score via the customer sentiment portion (block 1110). After receiving the marketing communication, John's actions affect each major component of the engagement score. By viewing the email he affects recency and conversion (block 1114). The purchase is counted as a transaction 1112. Choosing to share the marketing offer on Facebook and comment on how great it is affects both the social factor and customer sentiment (block 1114). John's engagement with the survey 1116 that is sent much later will affect the outbound conversion rate as well as customer sentiment via a free text survey question that was completed (block 1118). Finally, the company can attribute his twitter post (block 1120) to his contact record which affects the customer sentiment (by scoring the emotion of his post) as well as the social factor (block 1122).

The following table illustrates how interactions affect various factors or portions of the engagement score.

| Interaction | Portions of Engagement Score Affected |
|---|---|
| Visits company website | Recency, Transaction (web page view |
| | transaction) |
| Accepts chat | Recency, Transaction (chat and ticket |
| | creation transactions), Customer Sentiment |
| Receives marketing email | Recency, Transaction (email view, email |
| and chooses to share the | link click, purchase), Conversion, Social, |
| offer with his friends as | Customer Sentiment |
| well as making a purchase | |
| Fills out survey | Recency, Transaction (survey view, survey |
| | link click, survey submit), Conversion, |
| | Customer Sentiment |
| Twitter post | Customer Sentiment, Social |

The specific interactions noted in this table are for descriptive purposes and additional interaction types are contemplated and within the scope of the inventive subject matter.

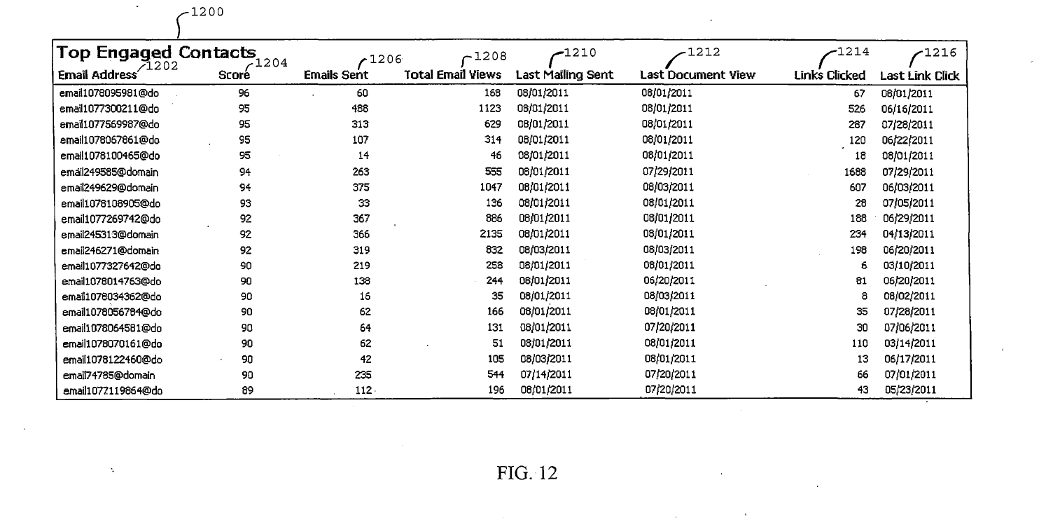

FIG. 12 illustrates an example screen image 1200 showing an engagement scorecard in which the engagement score 1204 is sorted in descending order and also includes data concerning emails sent 1206, emails viewed 1208, links clicked 1214, date of last mailing sent 1210, date of last document view 1212, and date of last link click 1216. In the example screen image, the scorecard is initially sorted by engagement score 1204 in descending order. However, any of the available columns can be used as sort criteria in either ascending or descending fashion.

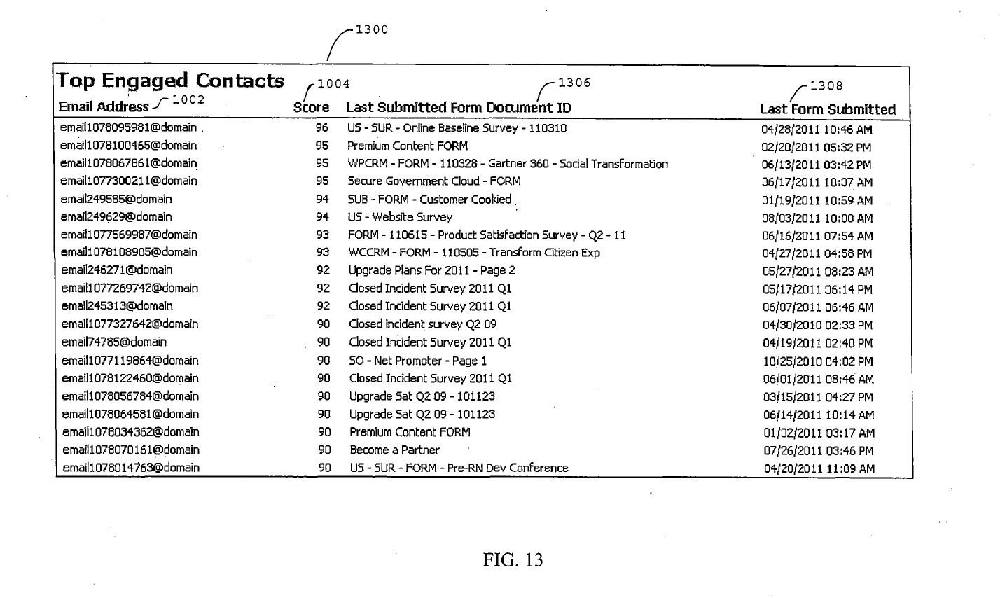

FIG. 13 illustrates an example screen image 1300 showing a different view of the engagement scorecard which includes the engagement score 1304 as well as information around the last web form submitted by the individual. Both the name of the web form 1306 and the time it was submitted 1308 are contained in this particular view. Once again, this is just one example of the many combinations of data that can be utilized to view engagement based on an overall score and other criteria.

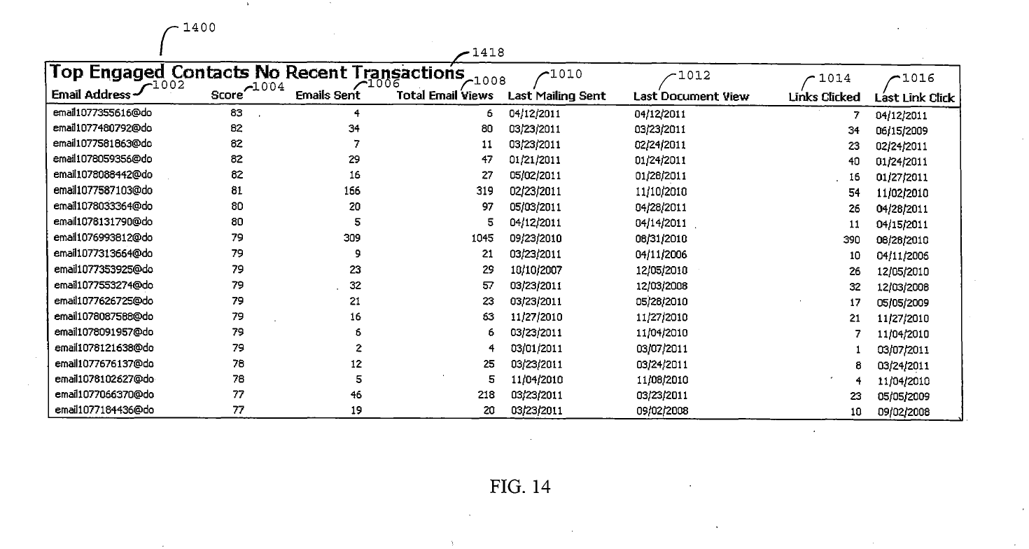

FIG. 14 illustrates an example screen image 1400 displaying the same information as FIG. 12 with the caveat that a filter has been added to only show those contacts that have not had any interactions in the last three months 1418. The example screen image 1400 shows yet another powerful aspect of the engagement scorecard in that it allows the user to specify various filters based off of any and all information available to the multichannel system. The view presented in example screen image 1400 shows data that could be utilized by a company as part of a retargeting campaign to attempt to reengage with contacts who were once very active with the brand but whose activity has fallen off in recent months.

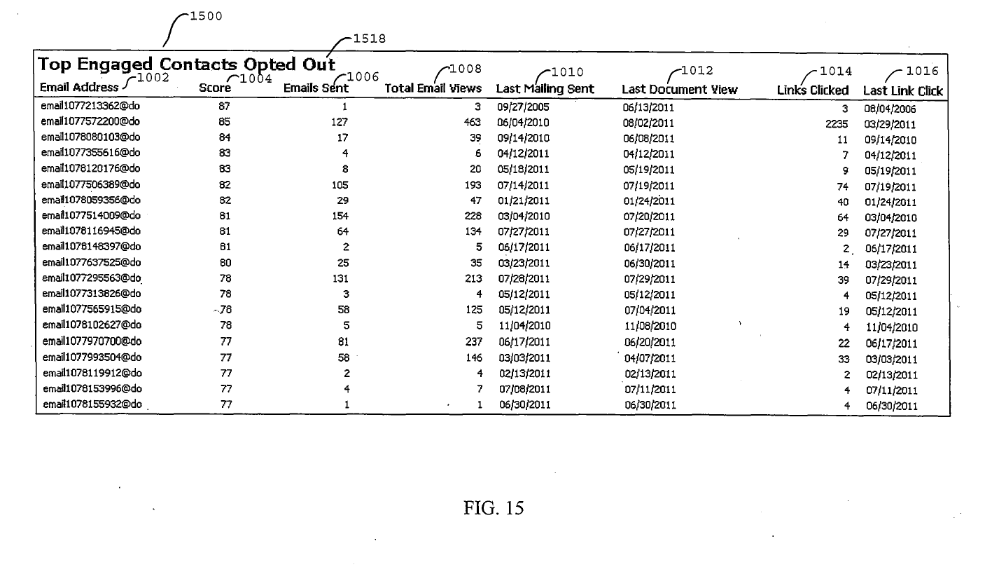

FIG. 15 illustrates an example screen image 1500 displaying the same information as FIGS. 12 and 14, but has a filter showing only contacts that have opted out of marketing communication with the business 1518. By examining the engagement patterns along with the final touch points (elements 1508, 1510, 1512, 1514, 1516) before the contact opted out, the business can limit future defectors and keep current contacts fully engaged with the brand.

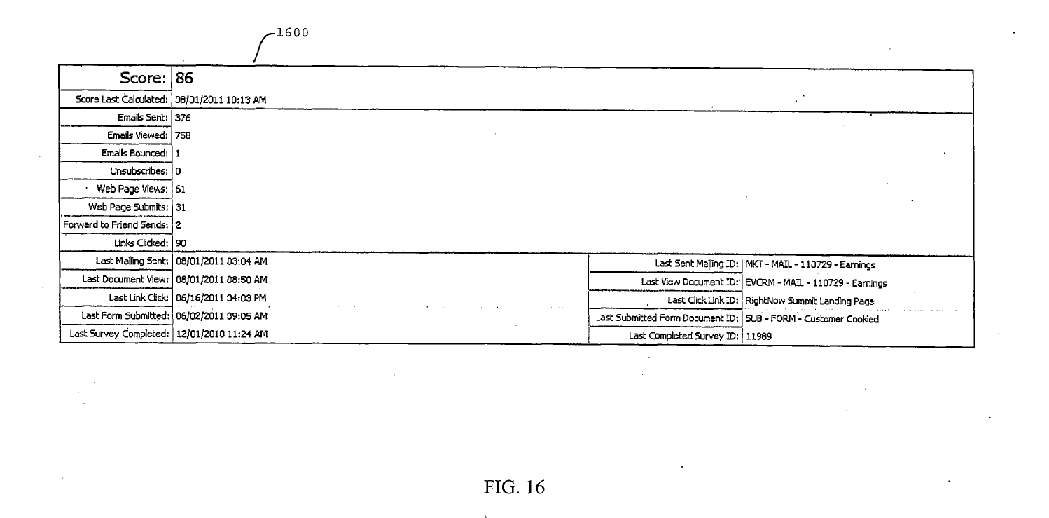

FIG. 16 illustrates an example screen image 1600 displaying information for a single contact. This view is desirable when contacts are being examined on an individual basis. Quite often this is valuable at the time when one-on-one contact with the customer is being made via one of the company's preferred communication channels. As is the case in FIGS. 12-16, this display can be modified to contain more personal information around the contact as well as other transactional data.

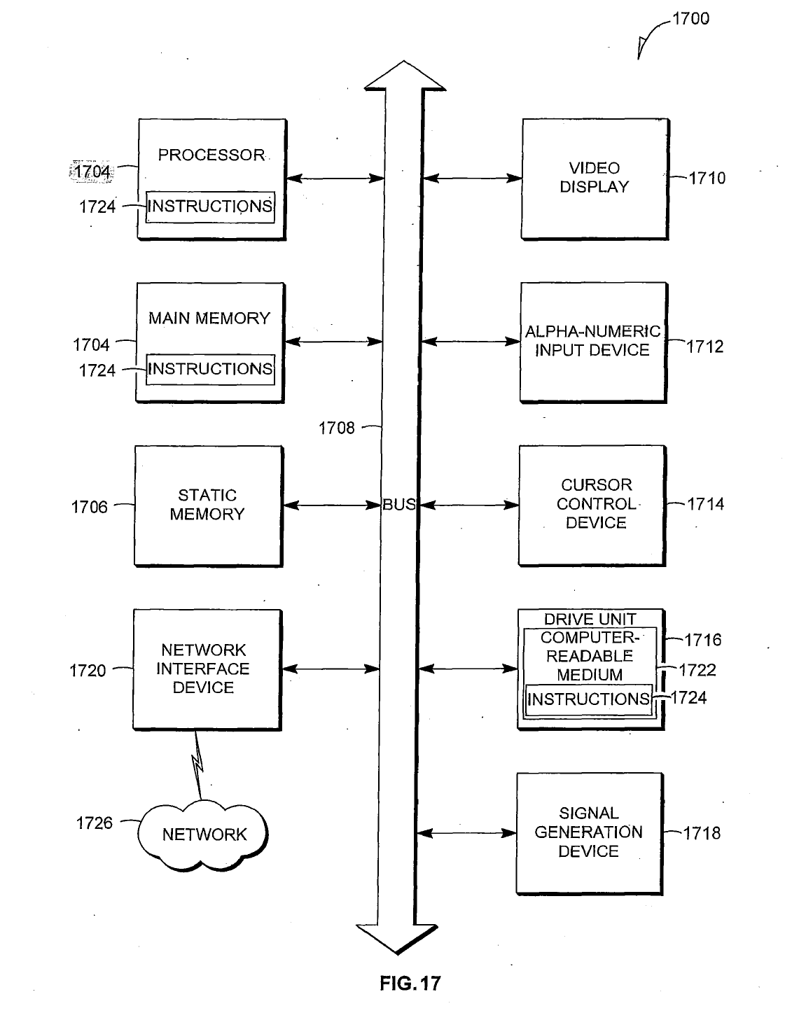

FIG. 17 is a block diagram of an example embodiment of a computer system 1700 upon which embodiments of the inventive subject matter can execute. The description of FIG. 17 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 17 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

In the embodiment shown in FIG. 17, a hardware and operating environment is provided that is applicable to both servers and/or remote clients.

With reference to FIG. 17, an example embodiment extends to a machine in the example form of a computer system 1700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 1700 may include a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). In example embodiments, the computer system 1700 also includes one or more of an alpha-numeric input device 1712 (e.g., a keyboard), a user interface (UI) navigation device or cursor control device 1714 (e.g., a mouse), a disk drive unit 1716, a signal generation device 1718 (e.g., a speaker), and a network interface device 1720.

The disk drive unit 1716 includes a machine-readable medium 1722 on which is stored one or more sets of instructions 1724 and data structures (e.g., software instructions) embodying or used by any one or more of the methodologies or functions described herein. The instructions 1724 may also reside, completely or at least partially, within the main memory 1704 or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to pedlar any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1724 may further be transmitted or received over a communications network 1726 using a signal transmission medium via the network interface device 1720 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A method for execution by one or more processors, the method comprising:
receiving, from a plurality of channels, data representing one or more interactions associated with a customer;
determining a conversion rate factor from the data;
determining secondary characteristics from the data; and
determining using the one or more processors for computing an engagement score for the customer according to the historical data representing one or more interactions, the conversion rate factor, and the secondary characteristics.

2. The method of claim 1, wherein determining secondary characteristics from the data includes determining a recency factor.

3. The method of claim 1, wherein determining secondary characteristics from the data includes determining a sentiment factor.

4. The method of claim 1, wherein determining secondary characteristics includes determining a social factor.

5. The method of claim 1, wherein the data representing one or more interactions with a customer includes one or more of data indicating an email to the customer was opened, data indicating a chat interaction, data indicating a phone interaction, data indicating a social network interaction, or data indicating a postal mail interaction.

6. The method of claim 1, wherein determining the engagement score includes applying a weighting to at least one of the data representing the one or more interactions, the conversion rate or one or more of the secondary characteristics.

7. The method of claim 1, and further comprising displaying the engagement score and one or more of the interactions in an engagement scorecard.

8. The method of claim 1, and further comprising determining a future interaction for the customer according to the engagement score.

9. The method of claim 1, and further comprising determining a segment for the customer according to the engagement score.

10. A system comprising:
one or more processors;
a customer management system configured to receive, from a plurality of channels, data representing one or more interactions with a customer; and
a scoring module executable by the one or more processors and configured to:
determine a conversion rate factor from the data;
determine secondary characteristics from the data; and
determine an engagement score for the customer according to the data representing one or more interactions, the conversion rate factor, and the secondary characteristics.

11. The system of claim 10, wherein the secondary characteristics include a recency factor.

12. The system of claim 10, wherein the secondary characteristics include a sentiment factor.

13. The system of claim 10, wherein the scoring module is configured to determine the engagement score in accordance with a social factor.

14. The system of claim 10, wherein the data representing one or more interactions with a customer includes one or more of data indicating an email to the customer was opened, data indicating a chat interaction, data indicating a phone interaction, data indicating a social network interaction, or data indicating a postal mail interaction.

15. The system of claim 10, wherein the scoring module is configured to apply a weighting to at least one of the data representing the one or more interactions, the conversion rate or one or more of the secondary characteristics.

16. The system of claim 10, and further comprising a user interface module to display the engagement score and one or more of the interactions in an engagement scorecard.

17. The system of claim 10, wherein the customer management system is further configured to determine a future interaction for the customer according to the engagement score.

18. The system of claim 10, wherein the customer management system is further configured to determine a segment for the customer according to the engagement score.

19. A machine-readable storage medium having stored thereon instructions for causing one or more processors to perform operations including:
receiving, from a plurality of channels, data representing one or more interactions associated with a customer;
determining a conversion rate factor from the data;
determining secondary characteristics from the data; and
determining using the one or more processors an engagement score for the customer according to the data representing one or more interactions, the conversion rate factor, and the secondary characteristics.

20. The machine-readable storage medium of claim 19, wherein determining secondary characteristics from the data includes determining a recency factor.

21. The machine-readable storage medium of claim 19, wherein determining secondary characteristics from the data includes determining a sentiment factor.

22. The machine-readable storage medium of claim 19, wherein determining secondary characteristics from the data includes determining a social factor.

23. The machine-readable storage medium of claim 19, wherein the data representing one or more interactions with a customer includes one or more of data indicating an email to the customer was opened, data indicating a chat interaction, data indicating a phone interaction, data indicating a social network interaction, or data indicating a postal mail interaction.

24. The machine-readable storage medium of claim 19, wherein determining the engagement score includes applying a weighting to at least one of the data representing the one or more interactions, the conversion rate or one or more of the secondary characteristics.

25. The machine-readable storage medium of claim 19, wherein the operations further comprise displaying the engagement score and one or more of the interactions in an engagement scorecard.

26. The machine-readable storage medium of claim 19, wherein the operations further comprise determining a future interaction for the customer according to the engagement score.

27. The machine-readable storage medium of claim 19, wherein the operations further comprise determining a segment for the customer according to an historical engagement score.
